(19) United States
(12) Patent Application Publication
(10) Pub. No.: US 2004/0019165 A1
(43) Pub. Date: Jan. 29, 2004

(54) Method for shortstopping polymerization processes in the manufacture of synthetic rubbers

(76) Inventors: Hartmut K. Stiller, Halle (DE); Hans A. R. Edel, Erdeborn (DE); Doris R. Marx, Mersburg (DE); Heinz-Juergen Bogen, Halle (DE); Ilona Guth, Merseburg (DE); Klaus Hoehne, Halle (DE); Wolfgang Krebes, Salzmuende (DE); Friedhelm Mathies, Halle (DE)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/415,323

(22) PCT Filed: Oct. 23, 2001
(86) PCT No.: PCT/US01/45609

(51) Int. Cl. C08F 4/00

(52) U.S. Cl. 526/217

(57) ABSTRACT

This invention is related to a new shortstopping combination for use in stopping free radical and redox intiated polymerization is the combination of hydroxylamine (free base) (HA) and i-propylhydroxylamine (IPAH). It is more effective as related N-alcylated-hydroxylamines with regard to mooney stability. The combination is not corrosive to metals used in commercial equipment fr emulsion polymerization and prevents the rust formation and the formation of nitrosamins, coagulate and precipitate.

This invention relates to an improved method for shortstopping polymerization processes for making synthetic rubber, such as butadiene-styrene copolymers.

Free radical or redox initiated emulsion polymerizations are generally terminated by mixing the latex with shortstopping agents, which are used to prevent a free radical or redox polymerzation reaction from proceeding to completion. The polymerization must be stopped to get a product of the desired characteristics. The properties of the polymers produced vary with the percentage of the monomers conversion.

The main application of free radical or redox polymerization is the emulsion polymerizations used in making elastomers such as styrene-butadiene rubber (SBR), butadiene rubber (BR) and acrylonitrile-butadiene rubber (NBR).

Much study has been made toward finding good short-stops and numerous compounds have been found quite useful. However, the compounds used heretofore have certain disadvantages and are not generally satisfactory with all types of polymerization systems.

Well known as conventional shortstopping agents are carbamates, hydoquinone, hydracine, polysulfide, nitrocompounds, N-alcylated hydroxylamines and/or other more (U.S. Pat. Nos. 5,348,372 3,296,177; .EP 656 371; EP-AO 437 293; DE-A-15 95 177).

N-monoalkylhydroxylamines have been suggested as shortstopping agents, particularly isopropylhydroxylamin (IPHA) in U.S. Pat. No. 5,384,372; WO 98/51714). In this case the final rubber was free of nitrosamines and their precursors.

The disadvantage of the described solutions is an not exactly stopping process by drifting the mooneyviscosity and the formation of coagulate and precipitate in the recovery vessels.

Another problem is the formation of secundary amines using N,N-dialcylated hydroxylamines and/or carbamates.

The problem has been excellently resolved by using a shortstopping agent as mixture of hydroxylamine (free base) und i-propylhydroylamine. In this way latex free of coagulate and precipitate and rubbers without nitrosamines and their precursors are produced. Never was found a drifting of the mooneyviscosity in latex or rubber.

The present invention relates to a method for terminating a free radical initiated emulsion polymerization comprising adding to the emulsion a shortstopping agent consisting of a 40 mixture of i-Propylhydroxylamin (IPAH) and Hydroxylamin (HA) (free base).

According to the invention there is disclosed a process for preparing a synthetic latex and rubber by free radical and redox initiated emulsion polymerization of a conjugated diene and a monoolefine in an aqueous medium and terminating the polymerization by the addition of a shortstopping agent combination consisting of hydroxylamin (free base) (HA) and i-propylhydroxylamin (IPAH).

The process being characterized in that a mixture consist of hydroxylamin (free base) (HA) and i-propylhydroxylamin (IPAH) is used as shortstopping agent comprising:

a) from 0.001 to 0.499 parts by weight of HA per 100 parts of monomers initially charged,

b) from 0.499 to 0.001 parts by weight of IPHA per 100 parts of monomers initially charged.

Preferably, a mixture of 0,01 to 0,2 parts by weight HA and 0,2 to 0,01 parts by weight IPAH is added.

The mixture of shortstopping agent is added in an amount from 0.005 to 0.2 parts by weight

each 100 parts by weight of initial monomer (phm), preferably 0.1 to 0.4 parts by weight of initial monomer (phm).

The manner by which the shortstopping agent is added is occured with convential techniques used in rubber polymerization processes. Preferably, the original solutions (HA 50 percent, IPHA 15 percent) and or an aqueous solution of the shortstopping mixture will be added to the polymerization reaction mass when the desired conversion is obtained

The preferable used polymerization system is a styrene butadiene polymerization.

The practice of this invention is further illustrated by references to the following examples which are intended to be representative rather than restrictive of the scope of this invention. The term “parts” as employed in the following examples refers to parts by weight of shortstopping agent per 100 parts of monomer charged.

### EXAMPLES

For free radical or redox initiated emulsion polymerization we carried out using a could soap styrene butadien polymerization is listed in table 1:

TABLE 1

| material | parts (phm) |
|---|---|
| styrene | 30 |
| butadiene | 70 |
| water | 215 |
| Fatty acid soap | 2.5 |
| Rosin acid soap | 2.5 |
| Total electrolyte | 0.45 |
| Chelated iron complex | 0.01 |
| Sodium formaldehyde sulfoxylate | 0.05 |
| Tert. dodecyl mercaptane | 0.14 |
| Di isopropylbenzenehydroperoxide | 0.05 |
| Hydroxylamin (HA) | 0.001 to 0.499 |
| i-propylhydroxylamin (lPAH) | 0.499 to 0.001 |

All polymerizations were carried out at 5° C. to about 60 percent conversion of monomer to polymer.

The shortstopping agent was then added.

Example 1 was shortstopped with a dilute aqueous solution of a 90/10 ratio by weight mixture of sodium dimethyldithiocarbamate (DTC) and N,N-diethylhydroxylamine (DEHA).

Example 2, 3, 4, 5, 6 7, and 8 was shortstopped with a dilute aqueous solution of hydroxylamine (HA) 50 percent and i-propylhydroxylamin (IPAH) 15 percent in water as a 22 percent solution. The results are given in table 2.

The mixture of both components was formed as batch or in linedosing, with or without deionized water from the original components. The preferential concentration could vary from 1 percent to 25 percent on the active components in water.

The addition of shortstop agent will be made after the desired degree of polymerization directly in the latex.

The presence of nitrosamines was determined by gaschromatographiy using a thermal energy analyzer, called BGA-method.

TABLE 2

| | | | | | Mooney | | |
|---|---|---|---|---|---|---|---|
| | | | | | | latex | |
| | | | | | | after | coagu- |
| | | | | | latex | mono- | late/ |
| | DTC/ | | | Nitros- | after | mer | precip- |
| | DEHA | HA | IPAH | amines* | short- | re- | itate |
| example | (phm) | (phm) | (phm) | (ppb) | stopp | covery | (% phr) |
| 1 | 0, 2 | — | — | 12, 7*¹ | 48 | 52 | 4, 5 |
| 2 | — | 0, 1 | 0, 1 | n.d.*³ | 48 | 48 | 0 |
| 3 | — | 0, 01 | 0, 19 | n.d. | 48 | 49 | 0 |
| 4 | — | 0, 08 | 0, 12 | n.d. | 48 | 48 | 0 |
| 5 | — | 0, 19 | 0, 01 | n.d. | 48 | 47 | 0 |
| 6 | — | 0, 02 | 0, 02 | n.d. | 48 | 48 | 0 |
| 7 | — | 0, 001 | 0, 449 | n.d. | 48 | 48 | 0 |
| 8 | — | 0, 449 | 0, 001 | n.d. | 48 | 48 | 0 |

*detection: N-nitrosodimethylamine, N-nitrosodietylamine, N-nitrosodipropylamine, N-nitrosodibutylamine, N-nitrosopiperidine, N-nitosopyrrolidine, N-nitosomorpholine
*¹Summary of N-nitrosodimethylamine and N-nitrosodiethylamine in rubber.
*²coagulate/precipitate was detected after monomer recovery
*³not detected

The shortstopp mixture was realized by mixing original solutions of of hydroxylamine (free base)(HA) 50 percent and i-propylhydroxylamin (IPAH) 15 percent in water.

Use of conventional shortstopping agents in sample 1 resulted in relatively high levels of nitrosamines being detected in the rubber. Also was found a high amount of coagulate using dimethyidithiocarbamate (DTC) and N,N-diethylhydroxylamine (DEHA) (example 1).

Surprisingly, use of hydroxylamine(HA) and i-propylhydroxylamine(IPAH) resulted in no nitrosamines and coagulate being detected. In the same way resulted a very mooney stable latex without drifting (Examples 2-8).

The advantage of the invention is a better shortstopp effect and a better prevention of popcorn formation in the gasphase and also in the liquid-(latex) phase. Besides the quantities of the two components of the mixture forming the shortstopping agent are lower that those required by the use of each single component, thus justifying the existence of a synergetic effect of the two components with respect to the shortstopping reaction.

1. A method of stopping free radical or redox polymerization comprising a mixture of hydroxylamine (HA) and i-propyihydroxylamine (IPAH) to a polymerizing mixture when a predetermined conversion has been reached.

2. The method of claim 1 wherein the mixture in an amount from 0.005 to 0.2 parts by weight each 100 parts by weight of initial monomer (phm) is added.

3. The method of claim 1 wherein the mixture consist of 0.001 to 0.499 parts by weight hydroxylamine(HA) and 0.499 to 0.001 parts by weight i-propylhydroxylamine (IPAH) by weight of initial monomer (phm), preferably 0.01 to 0.2 parts by weight hydroxylamine(HA) and 0.2 to 0.01 parts by weight i-propylhydroxylamine (IPAH) by weight of initial monomer (phm).

4. The method of claim 1 wherein the shortstopping agents are used in the original concentrations of the both components, IPAH 15 percent in water and HA 50 percent in water.
